(19) United States
(12) Patent Application Publication
(10) Pub. No.: US 2015/0040805 A1
(43) Pub. Date: Feb. 12, 2015

(54) CEILING CONSTRUCTION

(71) Applicant: HANS LINGL ANLAGENBAU UND VERFAHRENSTECHNIK GMBH & CO. KG, Krumbach (DE)

(72) Inventor: Andreas Hünlich, Waschenbeuren (DE)

(21) Appl. No.: 14/386,488

(22) PCT Filed: Mar. 19, 2013
(86) PCT No.: PCT/EP2013/055666

§ 371 Date: Sep. 19, 2014

(30) Foreign Application Priority Data
Mar. 19, 2012 (DE) 20 2012 100 976.5

(51) Int. Cl. F27D 1/02

(52) U.S. Cl. CPC F27D 1/025; F27D 1/028
USPC 110/335; 110/331

(57) ABSTRACT

A thermally expandable covering construction (1) for furnaces (2), in particular kilns or melting furnaces includes a preferably segmented cover (7) and, for the expansion-tolerant reception thereof on the edge side, a bracket (15) having a movable mounting (16) and having a clamping device (17) acting on the bracket (15). The clamping device (17) has a horizontally arranged clamping rod (31) which is loaded by a spring (33), is axially displaceably mounted on a fixed frame (29) and is pivotably connected to the bracket (15) at the front end by means of a bearing (26).

### CROSS REFERENCE TO RELATED APPLICATIONS

This application is a United States National Phase Application of International Application PCT/EP2013/055666 filed Mar. 19, 2013 and claims the benefit of priority under 35 U.S.C. §119 of German Utility Model 20 2012 100 976.5 filed Mar. 19, 2012, the entire contents of which are incorporated herein by reference.

### FIELD OF THE INVENTION

The present invention pertains to a ceiling construction for furnaces, in particular kilns for ceramics.

### BACKGROUND OF THE INVENTION

Thermally expandable ceiling constructions for kilns for ceramics, in particular bricks, which have a clamped ceiling consisting of ceiling segments, which extends transversely over a tunnel-like combustion chamber, are well known from practice. The arched or flat ceiling is supported on both longitudinal edges in a sloping position on abutments of a furnace side wall, which are formed by a fireproof brickwork. A tensioning means formed by tie rods extends at a distance over the ceiling between the furnace side walls and is connected there with stands. It holds the furnace wall together against the ceiling pressure.

### SUMMARY OF THE INVENTION

An object of the present invention is to provide an improved ceiling construction.

According to the present invention a ceiling construction is provided for furnaces, in particular kilns for ceramics. The thermally expandable ceiling construction has a preferably segmented ceiling and a bracket for the lateral expansion-tolerant mounting of the ceiling with a movable mount and a tensioning means acting on the bracket. The tensioning means has a tie rod arranged horizontally and loaded by a spring. The tie rod is mounted axially displaceably on a stationary frame and is pivotably connected with the bracket at the front end by means of a bearing.

The ceiling construction claimed has the advantage that it absorbs heat expansions in the ceiling better. This pertains, in particular, to temperature differences on the inside and outside of the ceiling and different expansions resulting herefrom. Further, edge pressures between the ceiling segments can be avoided.

The thermally expandable ceiling construction has a preferably segmented ceiling and a bracket with a multiaxial movable mount and a tensioning means acting on the bracket for the lateral expansion-tolerant mounting of the ceiling. The tensioning means has a tie rod which is arranged horizontally and is loaded by a spring, whereby the tie rod is axially displaceably mounted on a stationary frame and is pivotably connected with the bracket at the front end by means of a bearing.

A plurality of the brackets arranged on one or both ceiling edges, their mounts and the tensioning means may be present. The tensioning means may have one or more tensioning units with tie rod and spring. The spring tension can be adjusted with a clamping means and checked and monitored by means of a detection means.

With its mount movable on at least two axes and the tensioning means acting on the bracket, the bracket forms a laterally movable abutment for the ceiling, which can follow the different expansion patterns as well as deformations of the clamped ceiling resulting therefrom, e.g., an arched or flat ceiling. This also permits the absorption of tension differences in case of a change in temperature. At the same time, the clamping of the ceiling and its stabilization can be ensured. The ceiling is held securely in all operating positions and cannot crash. Subsidence effects of the ceiling can be compensated by a retightening of the tensioning means.

In the presence of a temperature gradient in the direction of a furnace, e.g., in the longitudinal direction of a tunnel furnace, the ceiling and also the bracket can be divided into a plurality of sections, which independently follow the locally different temperature and voltage requirements and adapt accordingly. A stepped contour permits a corresponding relative mobility of the sections, and preferably in conjunction with a labyrinth joint.

The ceiling construction may have a detection means for the detection of expansion of the ceiling. The expansion behavior during the heating up process can be detected and monitored hereby, which can occur outside the furnace. Abnormal changes in the expansion state, which may be caused, e.g., by excess temperature, structural destruction in a ceiling segment or the like, can be recognized and signaled in due time. This permits an occasional or permanent monitoring of the ceiling and furnace and the taking of corrective measures for avoiding damage or destruction of the ceiling construction and of the furnace. The detection means can be advantageously used in the mounting of the ceiling and the startup for the purpose of monitoring and error detection as well. It can be connected with an analyzing and storage means, with which the detection results can be recorded and be used for quality controls of the furnace function and of the process or product quality. The detection means may be associated with a tensioning means or be embodied in a different way.

The ceiling construction claimed also makes possible a simpler and better mounting of the ceiling in the furnace and correct adjustment of the ceiling clamping. In addition, the suitability for any flat or arched ceiling shapes is favorable. The furnace structure can be simplified and improved. Overall, the ceiling construction claimed offers a structural solution that is optimized in function and design effort and is particularly economical.

The present invention is shown in examples and schematically in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a cross section through a furnace with a ceiling construction and with a clampable ceiling;

FIG. 2 is a broken-off side view of the arrangement according to arrow II of FIG. 1;

FIG. 3 is a sectional and enlarged view of the ceiling edge with a movably mounted bracket and a tensioning means according to detail III of FIG. 1;

FIG. 4 is a cross section through a furnace with a variant of the ceiling construction and a clampable ceiling;

FIG. 5 is a perspective view of a stand construction with brackets;

FIG. 6 is a broken-off side view of the arrangement according to arrow VI of FIG. 4;

FIG. 7 is a sectional and enlarged view of the detail VII of FIG. 4;

FIGS. 8 through 10 show different perspective views of a tensioning unit; and

FIG. 11 is a longitudinal section through a tensioning unit.

### DESCRIPTION OF THE PREFERRED EMBODIMENTS

Referring to the drawings in particular, the present invention pertains to a ceiling construction (1) for a furnace (2). The present invention further pertains to a furnace (2) equipped with such a ceiling construction (1).

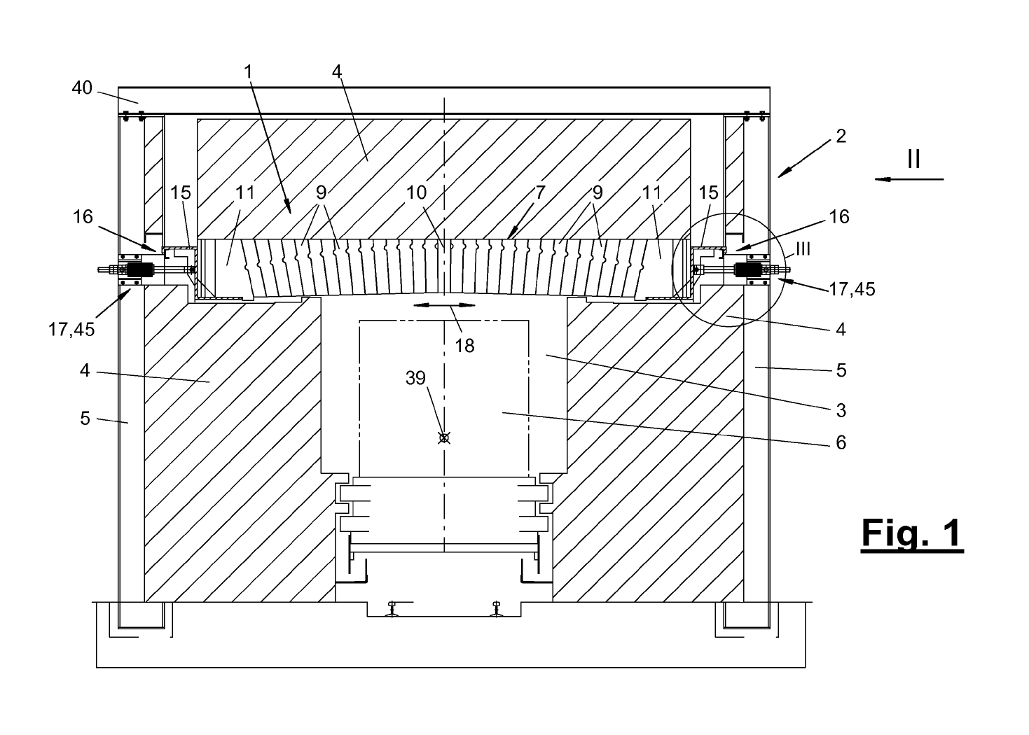

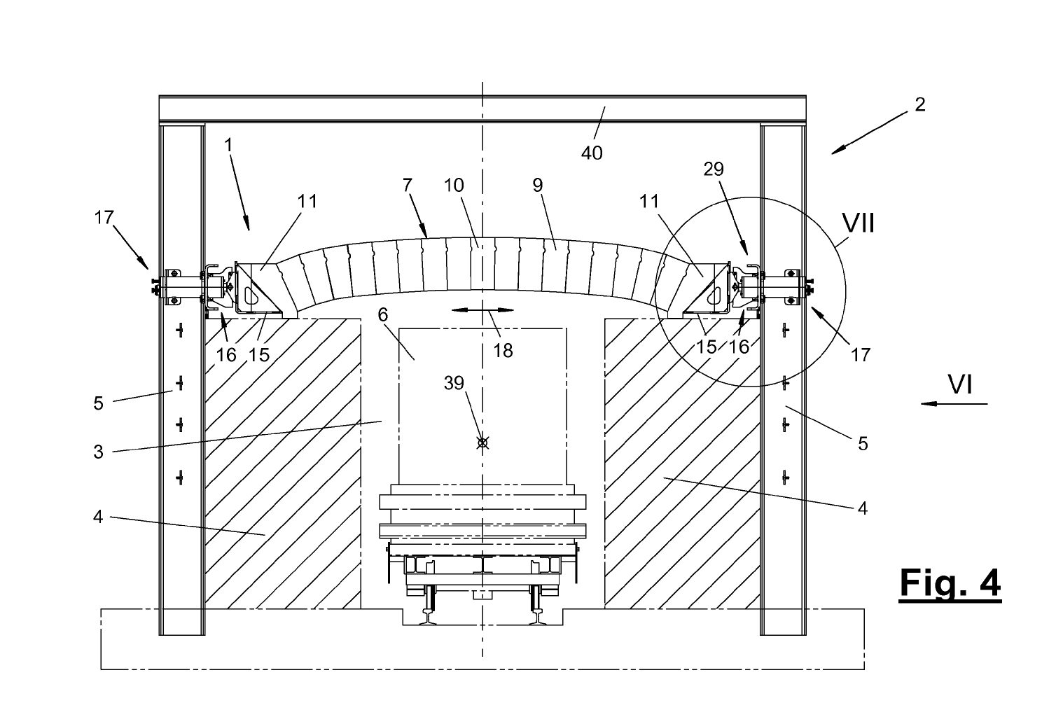

FIGS. 1 and 4 show the cross section of a furnace (2) with a ceiling construction (1), which has a clamped ceiling (7). The furnace (2) may be of any type of construction and size and be used for different purposes. In the exemplary embodiments, it is a high-temperature kiln for a furnace load (6), which is formed, e.g., by ceramic raw bricks, in particular fireproof products. As an alternative, the furnace (2) can be used for the heat treatment of other inorganic, non-metallic or even metallic products with corresponding adaptation, e.g., as a melting furnace. The products may be solids or liquids, in particular melts. In particular, the furnace (2) may be used for glass, metal, non-ferrous metal melts as well as for thermal processing systems for chemistry, energy and the environment.

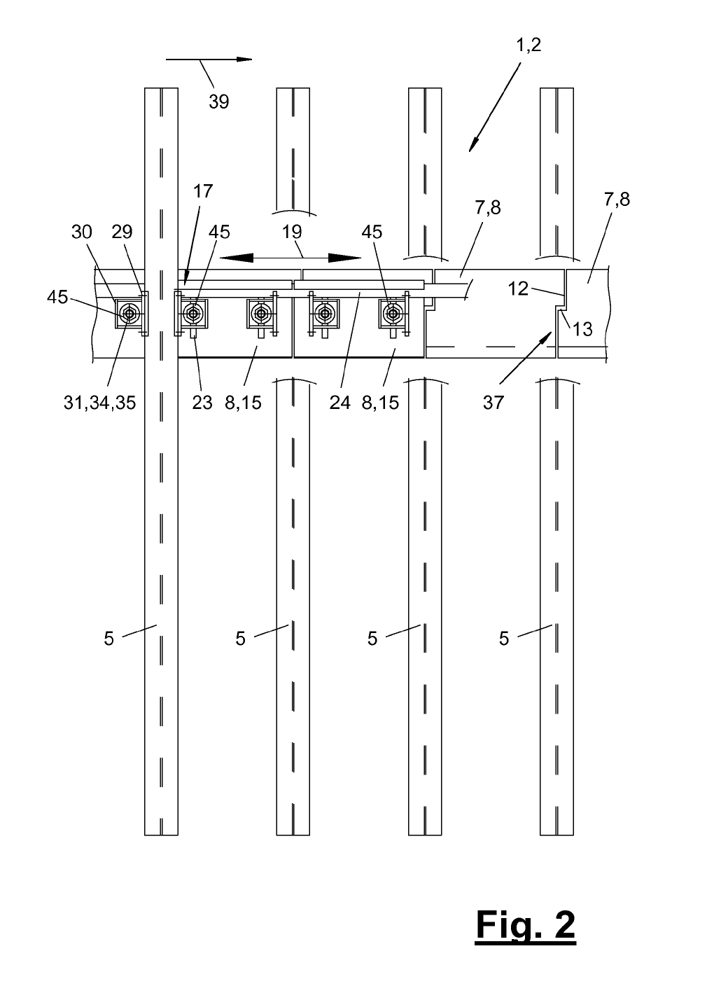

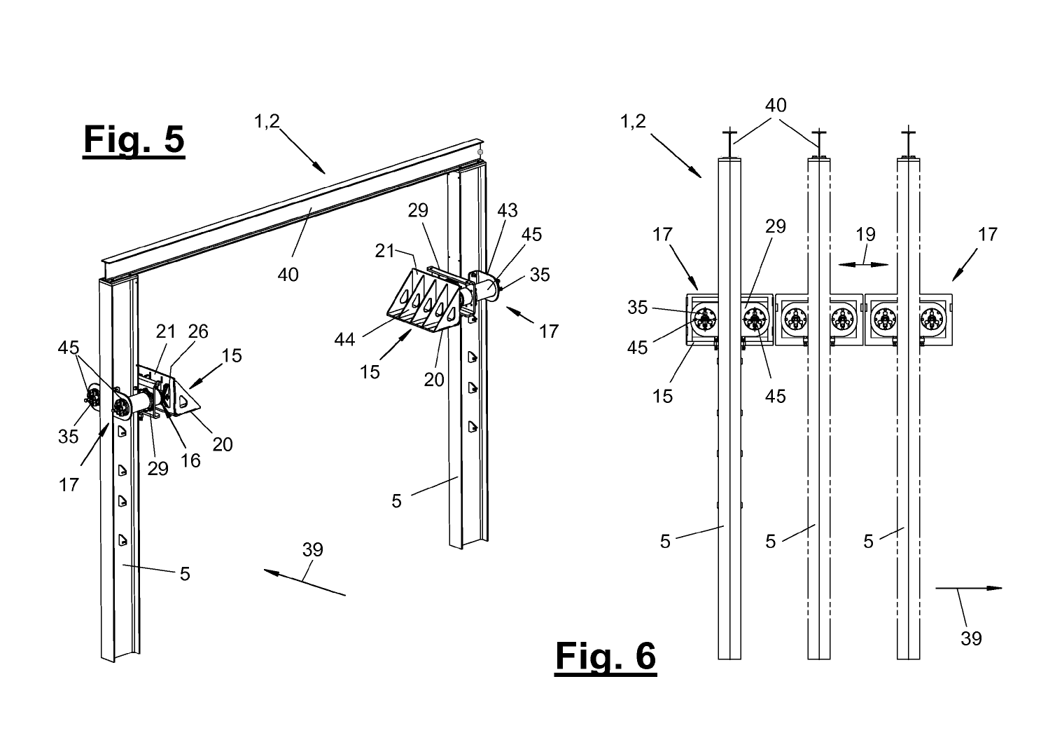

The furnace (2) has at least one combustion chamber (3), which is enclosed by a temperature-conform thick furnace wall (4) on the sides, by a floor at the bottom and by the ceiling construction (1) and its ceiling (7) at the top. Another additional part of the wall (4) overlapping the combustion chamber (3) may be located above the ceiling (7). The wall (4) may be designed in any suitable manner. It may comprise, e.g., fireproof brickwork, shown by shading in FIGS. 1 and 4, which is possibly surrounded on the outside by a steel jacket or by a fair-faced brickwork in the vertical area. In addition, a plurality of supports or stands (5), which are upright and spaced apart in the direction of a furnace (39) and which are made of metal, in particular steel, may be arranged on the side walls (4) on the outside, as this is shown, e.g., in FIGS. 2, 5 and 6. The stands (5) may be connected on the top side by means of a crossbeam (40) to a gate-like stand construction.

The ceiling (7) may overlap the side walls (4), in particular a fireproof brickwork there, at least in some areas. The clamped ceiling (7) may expand and deform differently here corresponding to the temperature exposure from the combustion chamber (3).

In the combustion chamber (3), the furnace load (6) is arranged stationarily or movably on a carrier, which is designed, e.g., as a dolly or component of a conveyor. The furnace (2) may be designed as a batch furnace or continuous-heating furnace, whereby in the last-mentioned case, the furnace load (6) is transported along the furnace axis (39) through the combustion chamber (3). The combustion chamber (3) may be designed, e.g., as an elongated tunnel. The furnace (2) has one or more heat generators (not shown), which are designed, e.g., as burners, hot air conductions or the like. The furnace (2) may have an essentially uniform temperature in the combustion chamber (3) or a temperature gradient existing in the direction of the furnace axis (39). Such an axial gradient may have an initial heat-up phase with subsequent high-temperature heating phase and subsequent cooling phase.

The ceiling (7) may have a one-part or multi-part design. It consists, e.g., according to FIGS. 1 and 4, of a plurality of ceiling segments (9, 10, 11), which are connected to one another in a row and are possibly guided to one another in a positive-locking manner with a tongue and groove connection. The ceiling segments (9, 10, 11) consist of a fireproof material, e.g., fireproof clay. At least in some areas, they have an inclined wall and a contact surface to the adjacent segment. The lateral ceiling segments (11) may have a thick design and have a rectangular contour on the outside as skewbacks. The central ceiling segment (10) is designed as a keystone. In the embodiment of FIG. 1 shown, a flat ceiling (7) is shown.

As an alternative, a design as an arched ceiling, e.g., according to FIG. 4 is possible, whereby the ceiling segments (9, 10, 11) have a correspondingly adapted and changed shape as wedge-shaped arch bricks. The lateral ceiling segments (11) may be supported on their adjacent furnace side wall (4) with a lower protruding projection. The row of ceiling segments (9, 10, 11) extends transversely to the furnace direction (39) in both exemplary embodiments shown.

The ceiling construction (1) further has at least one bracket (15) with a movable mount (16) and with a tensioning means (17) acting on the bracket (15). These means are used for the lateral and expansion-tolerant mounting of the ceiling (7).

In the exemplary embodiments shown and preferred, the ceiling (7) is mounted on both sides on the ceiling edges and the edge segments (11) there on brackets (15). A tensioning means (17), which preferably engages and acts on the bracket (15) from the outside, is associated with the respective bracket (15). The ceiling (7) with its ceiling segments (9, 10, 11) is also clamped in a spring-loaded manner hereby, whereby the tensioning means (17) absorbs ceiling expansions, on the other hand. The bracket (15) in addition to the mount (16) and the associated tensioning means (17) can be supported on the adjacent side wall (4) of the furnace (2), in particular on the stands (5) there. The tensioning means (17) may have one or more tensioning units (45) engaging the bracket (15).

FIGS. 1 through 3 and 4 through 11 show two variants of the bracket (15), its mount (16) and the tensioning means (17).

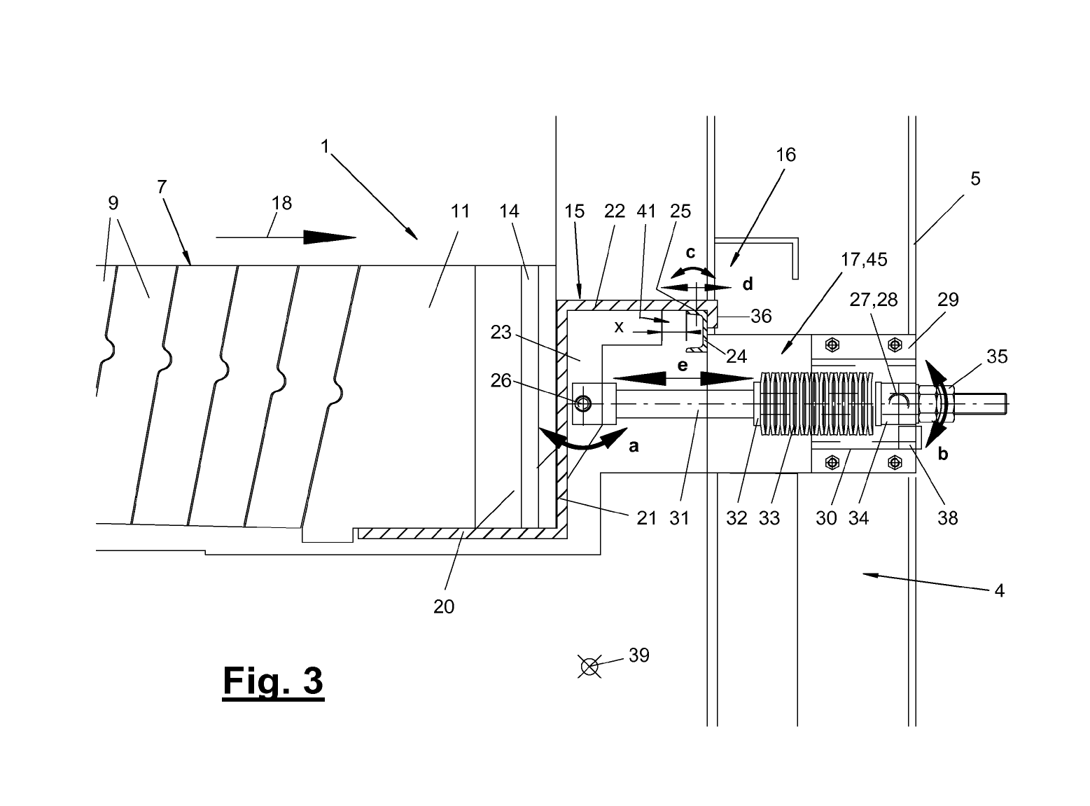

FIG. 3 illustrates the cross section of a bracket (15) according to the first variant. It accommodates at least one edge segment (11) of the ceiling (7) in a positive-locking manner. The bracket (15) has a multiply angular profile shape consisting of plate-shaped bracket and profile parts (20, 21, 22). The bracket (15) may consist of a suitable temperature-resistant material, e.g., steel or other metals. The bracket profile may be designed as a chamfered or welded sheet metal part.

An upright bracket part or support part (21) forms the lateral support of the adjacent edge segment (11), whereby possibly one or more pressure-resistant insulating layers (14) are arranged between them. A horizontal bracket part (20), projecting transversely to the combustion chamber, which forms a mounting plate of the edge segment (11) and possibly the insulating layer(s), is connected to the lower edge of the bracket part (21). Between the bracket part (20) and the bottom side of the edge segment (11), there may be a positive lock via profiling. A bracket part (22), which is likewise horizontal and directed outwards toward the wall (4), which forms a bearing part for supporting the bracket (15) and possibly has a retaining lug (36) unwound downwards at the free end, is connected to the upper edge of the bracket part (21). FIG. 3 shows this design. One or more stiffening ribs (23) may be arranged between the upper horizontal bracket part (22) and the upright bracket part (21).

The mount (16) of the bracket (15) is movable on multiple axes. It has, in particular, a plurality of rotatory and translatory bearing axes (a, b, c, d, e) as well as correspondingly associated bearings (25, 26, 27, 28). The tensioning means (17) can be integrated here into the mount (16) of the bracket (15).

The tensioning means (17) shown in FIG. 2 in the rear or outside view has two or more parallel tensioning units (45) arranged next to one another in the axial direction (39), which act together on the bracket (15).

As FIG. 3 illustrates in particular, the tensioning means (17) or its shown tensioning unit (39) has a frame (29), mounted in a relatively fixed manner, which is designed, e.g., as a mounting plate and is supported and fastened to a part of the wall (4), in particular to a stand (5). Further, the tensioning means (17) or its shown tensioning unit (45) has a horizontally arranged tie rod (31), which is pivotably connected about the bearing axis (a) at the front end by means of a bearing (26) with the bracket (15), e.g., with its stiffening rib (23).

The tie rod (31) is in turn displaceably guided in a sleeve-like pushing block (34) with a sliding bearing (28) along the translatory axis (e). The pushing block (34) is in turn rotatingly mounted on the frame (29) via a pivot bearing (27) with the rotatory bearing axis (b). The bearing axes (a, b) of the pivot bearing (26, 27) are aligned horizontal to, parallel to and along the furnace axis (39). They permit a pivoting and tiling movement of the bracket (15) in response to ceiling deformations which are initiated via the edge segment (11).

The upper horizontal bracket or bearing part (22) is supported on a bracket suspension (24), which is formed, e.g., by a horizontal mounting strip fastened to the stands (5), and is arranged above the push rod (31) as well as the pivot bearing (26, 27). As a result of this, a bearing (25), in particular a floating bearing, is formed, which, on the one hand, permits translatory shifting movements of the bracket (15) along the bearing axis (d) for the absorption of heat expansions (18) along the row of segments (9, 10, 11), and, on the other hand, also makes possible tilting movements about a rotatory bearing axis (c) parallel to the other bearing axes (a, b). The retaining lug (36) prevents the bracket (15) from detaching. The bearing (25) is located above and in the direction of the rod between the pivot bearings (26, 27).

As FIG. 3 illustrates, the horizontal leg of the stiffening rib (23) located under the bracket part (22) ends with a distance (x) in front of the retaining lug (36) and in front of the bracket suspension (24). The leg length and the distance (x) to the bracket suspension (24) are adapted to the tensioning means (17). In case of a failure of the spring(s) (33), in particular of the set or sets of disk springs, a maximum path of displacement along the translatory axis (d) in the outward direction is defined by the distance (x) and is adhered to relative to the bracket suspension (24). The said distance or path of displacement (x) may be variable and adjustable in order to take the thermal requirements and the respective structural conditions into account. The variability can be achieved by adjusting screws or other adjusting means, which are mounted on the bracket suspension (24) or on the bearing (25).

A safety limiting means (41) for the bracket (15) and for degrees of freedom of its mount (16) is formed by the bearing (25), the retaining lugs (36) and the rib distance.

Further, the tensioning unit (45) has a spring (33) associated with the tie rod or push rod (31), which is designed, e.g., as a wound-up compression spring and in the form of a set of disk springs. The spring (33) is supported on the front side via a stop (32) on the tie rod (31) and on the back side on the pushing block (34) and presses the bracket (15) toward the ceiling (7). Further, a clamping means (35), with which the tie rod (31) can be drawn outwards while supported on the pushing block (34) and compression, in particular pretensioning of the compression spring (33), acts on the push rod (31) on the outside. The clamping means (35) is formed, e.g., by a possibly tightened tensioning nut, which is screwed onto a thread on the push rod thread and presses against the back side of the pushing block (34). The spring (33) and the pushing block (34) can be accommodated with suitable clearance in a surrounding housing, which is fastened to the frame (29).

The ceiling construction (1) may have a detection means (38) for detecting ceiling expansions. For this, the detection means (38) may be arranged at any suitable site and be designed in any suitable manner. Preferably, it is associated with the tensioning means (17), in particular with each tensioning unit (45). It may be designed as a means for measuring force and/or travel. According to FIG. 3, a measuring means is arranged, e.g., on the frame (29) and picks up the shifting movement of the tie rod (31) along the axis (e) and possibly also a pivot movement about the axis (b). For this, the detection means (38) may have a suitable sensor mechanism together with an analysis means and a display, possibly also an alarm.

The detection means (38) may also be designed and used as a safety means for the mounting of the ceiling construction (1). For this case, it may be equipped with its own power supply, e.g., a battery, and a signaling means, e.g., an alarm diode. After setting the keystone (10) of the segmented ceiling (7), a weight, e.g., a defined test weight, is placed onto the apex of the, e.g., arched ceiling section. This weight corresponds to the additional load of the overlying insulating material, e.g., of the horizontal part of the wall (4), as well as an additional live load and a safety stop. By means of the slow lowering of bricking templates, the already pretensioned brackets (15) are loaded with the maximum possible clamping pressure. When the pretension was correctly selected and the springs (33), especially disk springs, correspond to the defined properties, the tie rods (31) will not change their position. In addition, a loosening of the clamping means (35), in particular tensioning nuts, will still be possible with an, even though small, necessary torque. The loosening of the clamping means (35) should also not bring about any change in position of the push rod (31). If the push rod (31) is moved, the length of the compressed set of springs (33) or the position of the push rod end is reduced. This is recognized by the detection means (38) and an alarm is triggered, which signals an incorrectly selected pretensioning or a failure or an interference of the springs (33). In addition, the state of the springs can be visually checked via a comparison of the individual compressed disk springs. An alarm is also triggered when, after loosening the clamping means (35), the tie rod (31) is moved in the opposite direction, i.e., in the direction of the segmented ceiling (7) by means of the tensioning means (17) and when a certain degree is exceeded. Thus, mounting errors during the setting of the ceiling segments or material defects in the ceiling segments (9, 10, 11) or even defects in the bracket (15) and its mount (16) can be detected. This safety monitoring may also be active for the entire duration of the mounting and issue alarm signals, when, e.g., the above-mentioned causes of defects first occur later due to subsidence effects.

In the simplest embodiment, a frame-fixed scale is present, on which the position of the clamping means (35) distanced in the furnace operation or of another part connected with the tie rod (31) can be read. In another variant, an end switch may be provided, on which, in case of a failure of ceiling segments (9, 10, 11), the clamping means (35) or a different part of the push rod (31) stops and signals a ceiling failure.

As FIG. 2 illustrates, the ceilings (7) and its ceiling segments (9, 10, 11) as well as the bracket (15) in the furnace direction (39) may be divided into a plurality of sections (8). A different expansion and deformation behavior of the ceiling sections (8) can be taken into account by means of this division into sections. Expansions (19) in the longitudinal direction or furnace direction (39) can also be absorbed by the division into sections.

In addition, FIG. 2 illustrates that adjacent sections (8) of the ceiling (7) and its ceiling segments (9, 10, 11) have corresponding, expansion-absorbing stepped contours (12) at the junction point (37). These may have a distance in the longitudinal direction (39) and form a labyrinth joint, which is possibly filled with a compressible insulating and fibrous material. In this case, a horizontal joint section (13) with a vertical clearance may also be present, which makes possible different collision-free expansion movements of the adjacent ceilings (7) and their segments (9, 10, 11) in response to temperature differences. The brackets (15) may also be spaced apart in the furnace direction (39), whereby they may have straight lateral edges.

The expansion patterns in a clamped ceiling (7) in the transverse direction (18) shown in FIGS. 1 and 3 may be very different corresponding to the temperature gradient in the combustion chamber (3). On the hot bottom side of the ceiling (7), the ceiling material, in particular the ceiling segments (9, 10, 11) expand more than on the cooler ceiling top side. The ceiling (7) is deformed accordingly, whereby the expansions can be absorbed by the translatory bearing axes (d, e) under compression of the spring(s) (33). The tilting torques possibly resulting during the expansion may be absorbed by the pivoting mount (16) of the brackets (15) on one or both sides, in particular the rotatory bearing axes (a, b, c). It is also possible here to respond to changes in temperature accordingly, which result during the heating up of the furnace (2) or of the combustion chamber (3) from room temperature up to the maximum operating temperature.

The one or more tensioning means (17) provide for an automatic expansion compensation and keep the preferably segmented ceiling (7) clamped and in a mechanically stable position at all operating temperatures. The respective spring (33) is designed here, such that it absorbs both the expansion travel and the forces and torques of the ceiling (7) and its ceiling segments (9, 10, 11) including the support loads of possibly insulating layers (14). In the mounting of the ceiling, e.g., the springs (33) can be pretensioned by means of the clamping means (35) up to a pressure value, which is required at room temperature in order to securely clamp a flat or arched ceiling (7). For the mounting of the ceiling (7), the bracket (15) is placed here in a defined position on the bracket suspension (24) and connected with the tie rod or tie rods (31). The bracing can be selected in such a way that the ceiling can be positioned between the lateral brackets (15) without the action of shaping. After the setting of the keystone (10) in the middle of the ceiling, the clamping means (35) can be loosened until the brackets (15) have clamped the row of segments under the action of the springs (33), and the clamping means (35) are then preferably released. The bracket (15) and the tie rod(s) (31) can then be moved back and forth along the translatory axis (d, e) under the action of the spring(s) (33).

FIGS. 4 through 11 show the variant of a bracket (15) mentioned in the introduction, its mount (16) and the associated tensioning means (17).

As in the first variant, the profiled bracket (15) has a carrying part (20) and an upright support part (21) as well as at least one stiffening rib (23) on the rear side for the pivot bearing (26). In addition, the bracket (15) may have one or more separating webs (44), which are arranged spaced apart one behind the other in the furnace direction (39), on the front side between the bracket parts (20, 21). A plurality of edge segments (11) can be accommodated next to one another in the compartments that are consequently formed. As an alternative, the separating webs (44) can mesh with corresponding grooves of a broad edge segment or skewback (11).

As FIGS. 6, 8 and 9 illustrate, with each bracket (15) is associated a tensioning means (17), which in turn consists of at least two tensioning units (45) lined up in parallel and in the furnace direction (39). The tensioning units (45) are supported by means of a common frame (29) and are fastened to a stand (5). The frame (29) in this case is designed as a U section which is arranged horizontally and along the furnace direction (39). In addition, the tensioning units (45) may also be supported and fastened on their rear side each with a metal fitting (43) to a stand (5).

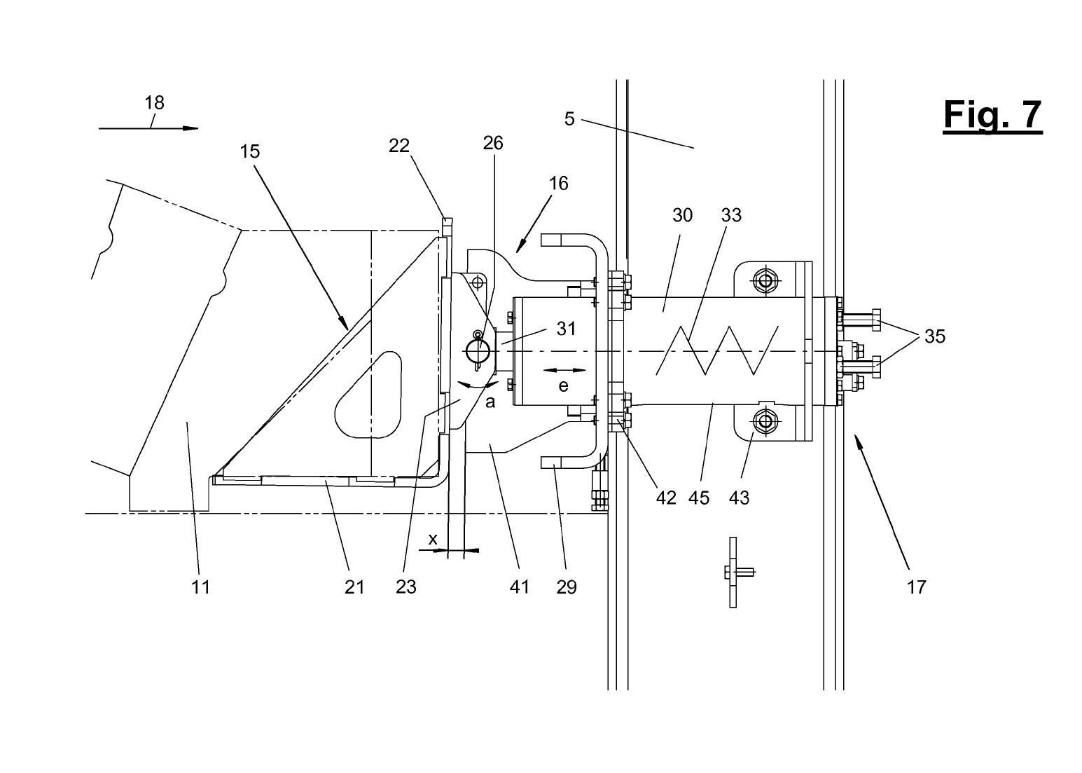

FIG. 7 shows a tensioning unit (45) in a side view and as an enlargement of detail VII of FIG. 4. The tensioning unit (45) is arranged by means of the frame (29) rigidly on a stand (5) or on the furnace side wall (4) and has a tie rod (31) arranged horizontally, which is arranged displaceably in the direction toward the ceiling (7) or toward the edge segment (11) and is loaded by a spring (33) in the direction toward the ceiling (7). The tie rod (31) has a preferably horizontal position, whereby, as an alternative, it may have a slightly inclined position. On the front end, it carries a cross bar, which is held on an end block and projects on this on both sides.

This cross bar forms the said pivot bearing (26) with bearing eyes in the rear-side ribs (23) of the bracket (15).

In this example, the mount (16) of the bracket (15) has fewer bearing axes than in the first variant of FIGS. 1 through 3. It has two axes and has only one translatory bearing axis (e) along the tie rod (31) and one rotatory bearing axis (a) about the pivot bearing (26).

On the frame (29), between the tensioning units (45) is arranged a safety limiting means (41), which can limit the maximum spring travel and also the maximum pivot angle of the bracket (16). The safety limiting means (41) has a plate that protrudes from the frame toward the ceiling (7), whereby the upright plate edge is spaced apart from the bracket (15), in particular its support part (21) by the maximum spring travel or path of displacement (x) shown in FIG. 7. The bracket (15) and the ceiling (7) are supported at a stop. The function is the same as in the first exemplary embodiment. The plate of the safety limiting means (41) has, in addition, an adapted height, such that it limits the pivot angle of the bracket (15) about the pivot bearing (26) in one or in both rotary directions by means of a stop.

FIG. 11 shows a tensioning unit (45) in the longitudinal section. The tie rod (31) and the wound-up spring (33), e.g., a set of disk springs, are axially movably accommodated in a tubular housing, which is sealed at both ends by means of a cover (46). The translatory bearing axis (e) of the tie rod (31) is formed by means of sliding bearings (28) in both covers (46). The tie rod (31) protrudes at least through the front cover (46) toward the ceiling (7).

The spring or the set of springs (33) is mounted between a front stop (32) rigidly connected with the tie rod (31) or supported and a rear pushing block (34). In this exemplary embodiment, the pushing block (34) has a disk-shaped design and is displaceably arranged in the housing (30). On the rear side, it is acted on by clamping means (35), which consists, e.g., of one or more, e.g., two or three, tensioning screws, which can be screwed through the rear cover (46) and can be fixed by means of tightening nuts or the like in a tensioned position. Via this clamping means (35), the spring (35) according to FIG. 11 can be compressed from the untensioned spring length (l) to the tensioned spring length (s), as a result of which the tensioning or spring travel (f) is available for compensating the ceiling expansions. In the exemplary embodiment shown, the spring travel (f) is limited by a stop of the pushing block (34) at the rear cover (46) and also corresponds here to the maximum path of displacement (x) of FIG. 7 preset by the safety limiting means (41). In another embodiment, the distance of the pushing block (34) from the cover (46) can be greater for the purpose of retensioning in case of ceiling subsidence, such that the spring travels (f) and (x) may deviate from one another under the circumstances.

In this second exemplary embodiment, the clamping means (35) can also be operated from outside the furnace side wall (4). Further, a detection means (38) may be present as in the first exemplary embodiment. It may, in particular, have one or more sensors of the type mentioned, which are not shown in the second variant for the sake of clarity.

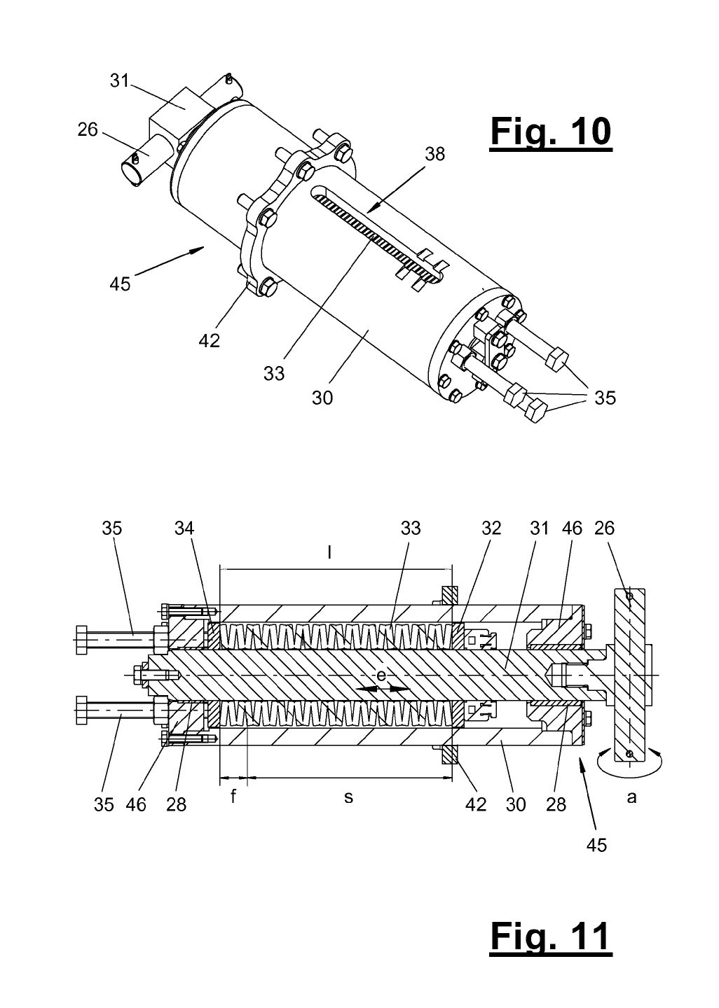

FIG. 10 shows a visual adjusting aid, which may represent a part of the detection means (38) or may form this detection means (38) in an especially simple embodiment. The adjusting aid consists of an axial slot on the jacket of the housing, through which its insides, in particular the spring (33) and the stop (32), are visible. At one end of the slot, one or more lateral markings may be provided on the housing (30), which can form a scale or end marks for determining the axial spring and stop. In this scale area, the stop (32), e.g., may be visible, whereby its position in the scale area signals the displacement or expansion of the ceiling (7). On the one hand, the pretensioning of the tensioning unit (45) or of the tensioning means (17) can be adjusted via this adjusting aid during the mounting. On the other hand, the expansion behavior of the ceiling (7) can be read hereby. Thanks to the tie rod (31), which is only displaceable over the translatory axis (e), the reading results are more accurate and more valid with regard to the cause.

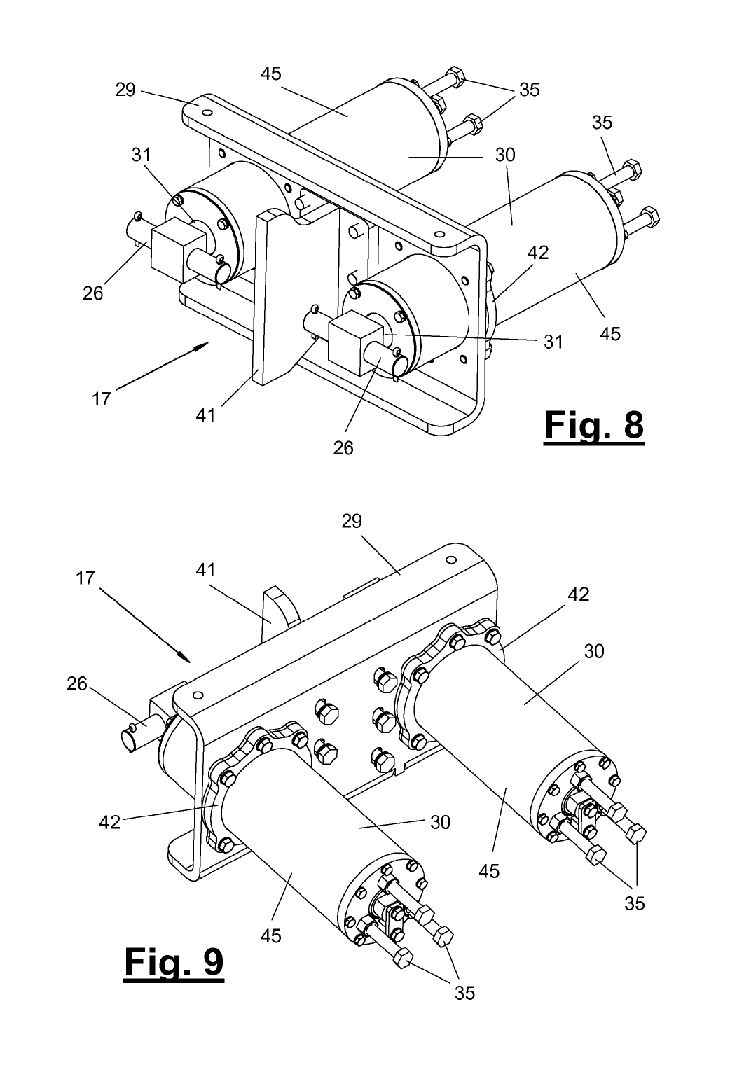

As FIGS. 8 and 9 illustrate concerning the mounting details, the housings (30) of the tensioning units (45) are inserted through corresponding openings in the upright cross web of the frame (29) and are permanently fixed to the cross web by means of a ring-shaped metal fitting (42). The second and, e.g., angular metal fitting (43) may be located at the rear end of the housing (30). The plate of the safety limiting means (41) may also be adjusted by means of adjusting screws, which are shown in FIGS. 8 and 9, for adjusting the maximum spring or displacement travel (x) in relation to the frame (29) shown in FIG. 7. An adjusting aid may be used here in the mounting of the ceiling.

In a side view VI of FIG. 4, FIG. 6 illustrates a sectional view of the arrangement of rows of a plurality of stands (5) in the furnace direction (39). Here, corresponding to the view of FIG. 2, the ceiling (7) may also be divided into a plurality of sections (8) in the furnace direction (39) and be accommodated in the brackets (15), which are lined up one behind the other in the direction (39). The arrangement and function may be the same as in the first exemplary embodiment.

A variety of variants of the described embodiments shown are possible. A bracket arrangement may be provided, e.g., only at one edge of the ceiling (7). The bracket (15) may have a different profile shape. Also, the mount (16) may have a different number and arrangement of bearing axes and individual bearings. In a batch furnace, the combustion chamber (3) may have a different layout, e.g., square. It may be possible to dispense with a division of the ceiling into sections (8). A batch furnace may have a ceiling segmenting of the type described, whereby the ceiling segments are arranged, e.g., transverse to the batch furnace entrance. The segmenting is, however, not absolutely necessary. In a chamber furnace (2), brackets (15) with preferably multiaxial mount (16) and associated tensioning means (17) may possibly be present on all ceiling edges. The structural design, mounting and kinematics of the tensioning means (17) may also be changed.

The displacement paths and pivot angle of the bracket (15) may be limited to a maximum by means of a different safety limiting means (41) in order to still keep the ceiling (7) secure in case of a failure of the spring(s) (33). For this, different types and designs of safety limiting means may be present, which can be designed as fixed or adjustable, e.g., by means of adjusting screws, stops, retaining lugs, etc.

The bracket suspension (24) may be designed differently for forming the bearing (25). It may, e.g., have a profile shape, which is used to reduce the frictional forces on the upper bracket part (22) and on the bearing (25). E.g., a design made of round steel with a mount is possible, on which the upper bracket part (22) can be displaced and unrolled.

In another variant, the furnace (2) may have a gas-tight design, whereby the peripheral wall (4) is surrounded with a sealed steel housing. In such a design, the push rod (31) may be lengthened in such a way that the tensioning means (17) or its tensioning unit(s) (45) lies completely outside the wall (4) and the steel housing. The push rods (31) may then be guided by means of correspondingly dimensioned sleeves, which are welded gas-tightly on the steel housing. The sleeve and the push rod may be connected by means of a flexible, gas-tight bellows.

The ceiling construction (1) claimed may also be used in so-called jack arches in furnace units, in which a graduated lowering of the ceiling (7) is necessary. On these arches rests a wall, which seals the furnace chamber (3) on the front side with a greater ceiling height. Under this wall, the furnace chamber is extended into a heat-treatment area with lower ceiling, e.g., for melting furnaces for the removal tank (melting pot) or walking beam furnace (intake-discharge).

While specific embodiments of the invention have been shown and described in detail to illustrate the application of the principles of the invention, it will be understood that the invention may be embodied otherwise without departing from such principles.

1. A ceiling construction for kiln furnaces for ceramics, the ceiling construction being a thermally expandable ceiling construction comprising:
a segmented ceiling;
a bracket for the lateral expansion-tolerant mounting of the segmented ceiling;
a movable mount; and
a tensioning means acting on the bracket, the tensioning means comprising a tie rod arranged horizontally and loaded by a spring, whereby the tie rod is mounted axially displaceably on a stationary frame and is pivotably connected with the bracket at the front end by a bearing.

2. A ceiling construction in accordance with claim 1, further comprising another bracket wherein the ceiling is mounted on both sides on the ceiling edges on the brackets with the tensioning means.

3. A ceiling construction in accordance with claim 1, wherein the stationary frame is arranged and supported on a stands of adjacent side walls of the furnace.

4. A ceiling construction in accordance with claim 1, wherein the tensioning means has a plurality of tensioning units acting together on the bracket, each with a spring-loaded tie rod.

5. A ceiling construction in accordance with claim 1, wherein the tie rod is loaded by the spring in the direction toward the ceiling.

6. A ceiling construction in accordance with claim 1, wherein the tensioning means further comprises a clamping means for adjusting the tension and a spring travel of the spring.

7. A ceiling construction in accordance with claim 6, wherein the tie rod, spring, clamping means and bearing of the tensioning means defines at least one tensioning unit that protrudes through the side wall, whereby the clamping means can be operated outside a combustion chamber of the furnace.

8. A ceiling construction in accordance with claim 1, wherein the tie rod is displaceably mounted in a pushing block or a housing.

9. A ceiling construction in accordance with claim 1, wherein the pushing block is pivotably mounted on the frame.

10. A ceiling construction in accordance with claim 1, wherein the housing is rigidly fastened to the frame.

11. A ceiling construction in accordance with claim 1, wherein the tensioning means has a safety limiting means for the path of displacement and the pivot angle of the bracket.

12. A ceiling construction in accordance with claim 1, wherein the bracket accommodates an edge segment of the ceiling in a positive-locking manner.

13. A ceiling construction in accordance with claim 1, wherein the ceiling has a plurality of ceiling segments lined up in one direction as well as connected with one another in a positive-locking manner.

14. A ceiling construction in accordance with claim 1, wherein the ceiling and the ceiling segments as well as the bracket are divided into a plurality of sections in another transverse direction.

15. A ceiling construction in accordance with claim 14 wherein adjacent sections have corresponding expansion-absorbing stepped contours.

16. A ceiling construction in accordance with claim 1, wherein the ceiling is designed as a flat ceiling or arched ceiling.

17. A ceiling construction in accordance with claim 1, wherein the bracket is formed of a heat-resistant material and has an angular profile shape.

18. A ceiling construction in accordance with claim 1, wherein the mount of a bracket has two or more bearings and two or more rotatory and/or translatory bearing axes.

19. A ceiling construction in accordance with claim 1, wherein the ceiling construction has a detection means for the detection of ceiling expansions.

20. A ceiling construction in accordance with claim 19, wherein the detection means is intended and designed for the detection of mounting errors of the ceiling construction.

21. A ceiling construction in accordance with claim 19, wherein the detection means is arranged at the tensioning means and is designed as a means for measuring force and/or travel.

22. A kiln furnace for ceramics, the kiln furnace comprising:
a walls; and
a thermally expandable ceiling construction (1), wherein the ceiling construction is a thermally expandable ceiling construction comprising:
a segmented ceiling;
a bracket for the lateral expansion-tolerant mounting of the segmented ceiling;
a movable mount; and
a tensioning means acting on the bracket, the tensioning means comprising a tie rod, a spring and a bearing, wherein the tie rod is arranged horizontally and loaded by the spring, the tie rod is mounted axially displaceably on a stationary frame and is pivotably connected with the bracket at a front end by the bearing.

23. A kiln furnace in accordance with claim 22, wherein the furnace has a chamber-shaped or tunnel-shaped combustion chamber, whereby the ceiling segments are arranged transversely to a chamber entrance or to a tunnel axis.

24. A kiln furnace in accordance with claim 22, wherein:
the segmented ceiling is divided into a plurality of sections in another transverse direction; and
the furnace has a tunnel-shaped combustion chamber, whereby the sections are arranged along the tunnel axis.

25. A kiln furnace in accordance with claim 22, wherein the furnace wall is a side wall with gate-like stand construction.
